(19) United States
(12) Patent Application Publication
(10) Pub. No.: US 2026/0012084 A1
(43) Pub. Date: Jan. 8, 2026

(54) DISCHARGE EQUIPMENT AND ELECTRICAL EQUIPMENT

(71) Applicant: Robert Bosch GmbH, Stuttgart (DE)

(72) Inventors: Chao Huang, Suzhou (CN); Klaus Liu, Suzhou (CN); Geralt Yi, Suzhou (CN)

(21) Appl. No.: 19/259,131

(22) Filed: Jul. 3, 2025

(30) Foreign Application Priority Data
Jul. 3, 2024 (CN) 202410888083.6

(51) Int. Cl. H02M 1/32

(52) U.S. Cl. CPC H02M 1/322

(57) ABSTRACT

Embodiments of the present disclosure provide, among other things, for a discharge equipment and electrical equipment. In one example, the discharge equipment comprises: a primary discharge circuit, configured to couple to a to-be-discharged device in an electrical device, and including a controllable switch configured to be connected to form a discharge loop to discharge the to-be-discharged device and configured to be turned off to cut off the discharge loop to cease discharge of the to-be-discharged device; and a protective circuit coupled to the primary discharge circuit and configured to turn off the controllable switch if the discharge voltage of the to-be-discharged device falls below a threshold during discharge. Through the present scheme, the discharge equipment may protect itself from damage caused by sustained discharge and heat.

### BACKGROUND

The present disclosure relates to the field of power technology, and more particularly, to discharge equipment and electrical equipment including the discharge equipment.

High voltage electrical equipment is typically provided with a discharge circuit. The discharge circuit may, in some cases, discharge an energy storage device such as a capacitance inside the device. For example, the discharge circuit may form a discharge loop for the capacitance inside the device after the electrical device is cut off, thereby completely releasing the charge remaining in the capacitance to ensure the safety of the device and personnel.

The discharge circuit within the electrical equipment is typically designed to allow energy of energy storage devices such as capacitance to be fully and rapidly released, and thus will be designed to have a greater discharge power. However, such a larger discharge power can result in severe heating of the device in the discharge circuit and, in some cases, a very high risk of damage. Currently, there is a lack of effective means to protect and prevent damage to the discharge circuit due to persistent severe fever.

### SUMMARY

To address at least in part the above and other possible problems, embodiments of the present disclosure provide for a discharge equipment and electrical equipment comprising the discharge equipment.

According to an aspect of the present disclosure, provide an electrical discharge equipment comprising: a primary discharge circuit, adapted to couple to a to-be-discharged device in an electrical device, and including a controllable switch configured to be capable of being connected to form a discharge loop to discharge the to-be-discharged device and capable of being turned off to cut off the discharge loop to cease discharge of the to-be-discharged device; and a protective circuit coupled to the primary discharge circuit and configured to turn off the controllable switch if the discharge voltage of the to-be-discharged device falls below a threshold during discharge.

In another aspect of the present disclosure, provide an electrical equipment. The electrical device includes a to-be-discharged device and a discharge equipment according to a first aspect, the discharge equipment being coupled to the to-be-discharged device.

The Summary of the Invention is provided in part to introduce a selection of concepts in a simplified form, which will be further described in the embodiments below. The Summary of the Invention is not intended to identify key or primary features of the disclosure, nor is it intended to limit the scope of the disclosure.

### BRIEF DESCRIPTION OF THE DRAWINGS

The exemplary examples of the present disclosure will be described in further detail in conjunction with accompanying drawings in order to further clarify the above-mentioned and other objectives, features, and advantages of the present disclosure, wherein in the exemplary examples of the present disclosure, the same reference number typically represents the same part.

FIG. 1 shows a schematic circuit block diagram of an electrical device, consistent with embodiments of the present disclosure.

FIG. 2 shows a schematic circuit block diagram of a discharge equipment, consistent with embodiments of the present disclosure.

FIG. 3 shows a schematic detailed circuit diagram of a discharge equipment, consistent with embodiments of the present disclosure.

### DETAILED DESCRIPTION

The examples of the present disclosure will be described in further detail below with reference to the accompanying drawings. Although examples of the present disclosure are shown in the drawings, it should be understood that the present disclosure can be implemented in various forms and should not be limited to the examples set forth herein. Rather, these examples are provided for the purpose of making the disclosure more thorough and complete and are capable of conveying the scope of the disclosure completely to those skilled in the art. Those skilled in the art can derive alternative technical solutions from the following description without departing from the spirit and scope of protection of the present disclosure.

As used herein, the term “comprise” and variations thereof mean open inclusion, i.e., “including but not limited to”. Unless specifically stated, the term “or” means “and/or”. The terms “based on” and “consistent with” mean “based, at least in part, on” and “consistent, at least in part, with”. The terms “one example” and “an embodiment” mean “at least one example” and “at least one embodiment”. Other explicit and implicit definitions may be included below.

As previously described, the discharge circuit may discharge the energy storage device inside the electrical equipment. In order to be able to rapidly release the charge in the energy storage device, the discharge circuit typically has a greater discharge power, resulting in a severe heating of the device of the discharge circuit. Under normal circumstances, when electrical equipment is de-energized and the discharge circuit is used to release the residual charge of the energy storage device, the discharge will not last for too long, so the heat generated by this short discharge is not enough to damage the discharge circuit and its devices. However, in some instances, a condition may arise in which the energy input of the energy storage device is sustained after the discharge circuit begins to discharge. For example, when the discharge circuit is discharging the capacitance, power to the electrical device is not disconnected or other sources of power may be present and energy is still input into the capacitance. As such, the discharge circuit is severely heated by sustained discharge at higher power. Such sustained heat may cause damage to the discharge circuit and its devices. Moreover, the control logic of the discharge circuit typically defaults to always turning on the discharge after the electrical device is powered off or down to ensure that the energy remaining from the energy storage device is released. Thus, if the energy storage device is continuously input with energy, the discharge circuit and its devices will inevitably continuously discharge and heat until they are burned down.

Embodiments of the present disclosure provide an improved discharge scheme. In this improved solution, by setting up a protection circuit, the discharge circuit can be cut off if the energy storage device is continuously input, thereby effectively protecting the discharge main circuit to avoid damage caused by continuous discharge and heat.

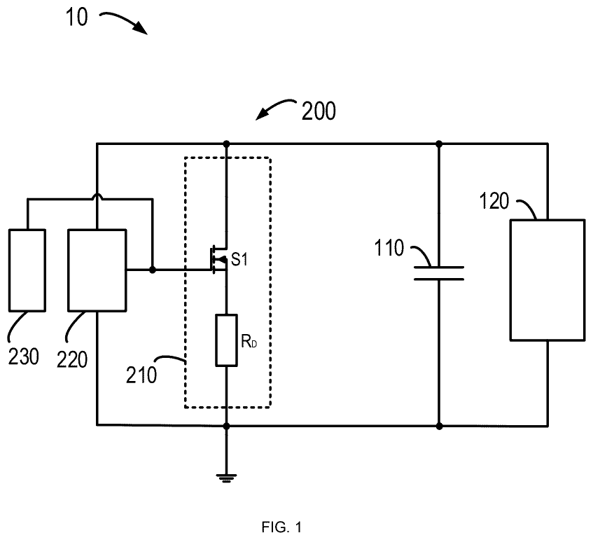

FIG. 1 shows a schematic circuit block diagram of an electrical device 10, consistent with embodiments of the present disclosure. As an example, the electrical equipment 10 may be a power conversion device, such as a drive mechanism for a compressor in a vehicle, or an on-board charger (OCC). The electrical device 10 may include a to-be-discharged device 110 and a circuit part 120. The circuit part 120 may include any appropriate electrical elements, components, and circuit for achieving the functions of the electrical device 10, such as switch devices, inductances, rectifiers, inverters, DC-DC converters, motors, etc. In an embodiment, the to-be-discharged device 110 may be a capacitance. For example, the to-be-discharged device 110 may be a busbar capacitance across a DC bus bar of a power conversion device or may be a combination of multiple capacitors in the same location or different locations of the power conversion device. However, it will be understood that the to-be-discharged device 110 is not so limited, but may be other type of energy storage device capable of storing charge and requiring a discharge operation.

As shown in FIG. 1, the electrical device 10 further includes a discharge equipment 200 coupled to the to-be-discharged device 110. For example, the discharge equipment 200 may be received across two ends of the capacitance to be discharged for discharging the discharge capacitance after the electrical device 10 has been cut off.

According to an embodiment of the present disclosure, the discharge equipment 200 includes a primary discharge circuit 210, which may be coupled to the to-be-discharged device 110 and includes a controllable switch S1. This controllable switch S1 is turned on when the discharge equipment 110 is being discharged to form a discharge loop and is turned off when the discharge equipment 110 is being discharged. By way of example, the controllable switch S1 may actively or passively perform a discharge operation under the control of a controller (not shown) of the electrical device 10. For example, when the electrical device 10 is running normally, the normally powered controller may signal the controllable switch S1 off to avoid discharge operations of the primary discharge circuit affecting the operation of the electrical device 10; and when the electrical device 10 is stopped and cut off, the controller is also cut off and unable to signal the shutdown, whereby the controllable switch S1 is turned on by default forming a discharge loop from the to-be-discharged device 110 to the primary discharge circuit to release the residual charge or electrical energy in the to-be-discharged device 110. In one example, the controllable switch S1 may be an N-type metal-oxide semiconductor field-effect transistor (N-type MOSFET). However, the controllable switch S1 may also be a P-type MOSFET or other type of switch device, such as an insulated grid bipolar transistor (IGBT), a junction field-effect transistor (JFET), a bipolar junction transistor (BJT), a gate turn-off (GTO) thyristor, a MOS-controlled thyristor (MCT), an integrated grid-switch (IGCT) thyristor, a silicon-carbide (SiC) switch device, or a GaN switch device, etc.

In some embodiments of the present disclosure, the primary discharge circuit 210 also includes a discharge resistance RD coupled in series with the controllable switch S1. In this way, residual energy from the device 110 can be dissipated on the discharge resistance RD to enhance the discharge and energy dissipation capabilities of the primary discharge circuit 210. It will be understood that the implementation of the primary discharge circuit 210 is not so limited and may take other forms of circuitry, e.g., the primary discharge circuit 210 may also dissipate energy on the controllable switch S1 and discharge lines without setting resistance, or may be formed by the MOSFETs forming various constant current sources.

In some embodiments of the present disclosure, the discharge equipment 200 may include a main drive circuit 230 coupled to the controllable switch S1. Main drive circuit 230 may drive the controllable switch S1 from the off state to the on state to turn on the discharge according to an indication of the controller of electrical device 10. For example, when the electrical device 10 is finished running and de-energized, the main drive circuit 230 may cause the controllable switch S1 to be turned on to turn on the discharge operation for the to-be-discharged device 110.

According to an embodiment of the present disclosure, the discharge equipment 200 further includes a protection circuit 220. The protection circuit 220 is coupled to the primary discharge circuit 210. During discharge of the device 110, the protection circuit 220 may turn off the controllable switch S1 if the descent rate in the discharge voltage of the device 110 is below a threshold.

In particular, during normal discharge of the residual charge or energy of the discharge equipment 110 by the primary discharge circuit 210, the discharge voltage across the to-be-discharged device 110 continues to drop until the residual charge or energy is fully released. However, in some instances, the to-be-discharged device 110 may still be subject to sustained input energy during the discharge process. For example, when the primary discharge circuit 210 is on discharge, the power supply that powers the electrical device 100 may not have been disconnected and thus continues to power the to-be-discharged device 110, or there may be other power supplies that continuously power the to-be-discharged device 110, such as when the electrical device 100 is an in-vehicle power conversion device, the vehicle traction motor, as a generator, in the trailer condition may be continuously powering the to-be-discharged device 110 of electrical device 100. In these abnormal cases, the discharge voltage of the to-be-discharged device 110 will not drop at a desired descent rate. As such, a descent rate in discharge voltage may be obtained and a determination made as to whether the discharge process is normal and whether there is still energy for sustained input into the to-be-discharged device 110 based on whether the voltage drop rate is too low. When the obtained descent rate of the discharge voltage is below a predefined threshold, an anomaly in discharge can be determined, whereby the controllable switch S1 is turned off to interrupt discharge to protect the primary discharge circuit from damage caused by sustained severe heat. Additionally, once the circuit design of the primary discharge circuit 210 is determined, the voltage change curve of the discharge process will also be determined, and the discharge voltage will necessarily have a descent rate. Thus, in one example, the threshold of the descent rate may be predefined as a minimum descent rate equal to or lower than the normal discharge voltage change curve. In this way, it may be easy and accurate to determine whether the discharge process is normal and trigger a discharge ceasing in the event of an anomaly. In an embodiment, the threshold of the descent rate may be set to a value between 200 volts/second and 500 volts/second. For example, the threshold may be set to 200 volts/second, 300 volts/second, 400 volts/second, or 500 volts/second.

It can be seen from this that the discharge equipment can rely on itself to achieve self-protection during discharge regardless of whether the controller of the electrical device 10 and related detection devices (e.g., voltage and current sensing devices) are working properly by setting up the protection circuit 220. Once the to-be-discharged device 110 from the electrical device 10 is continuously input with energy during the discharge process, the discharge equipment 200 may monitor the abnormality in a timely manner and turn off the discharge function before damage. In addition, in some high-intensity discharge conditions, such as a voltage-laden drop test, the discharge equipment 200 may also ensure that operations such as the test can be safely, quickly, and compliantly completed.

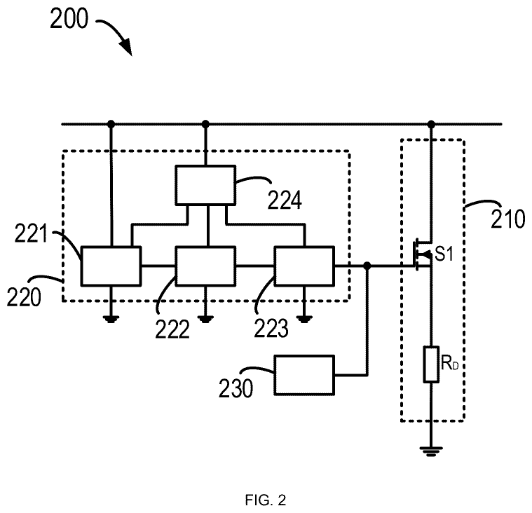

FIG. 2 shows a schematic circuit block diagram of a discharge equipment 200, consistent with embodiments of the present disclosure. As shown in FIG. 2, the protection circuit 220 of the discharge equipment 200 may include a detection circuit 221, a comparison circuit 222, and a drive circuit 223. The detection circuit 221 may detect the descent rate of the discharge voltage of the to-be-discharged device 110. To this end, the detection circuit 221 may be coupled to the primary discharge circuit 210 or to the to-be-discharged device 110, such as where the detection circuit 221 may be threaded across both ends of the primary discharge circuit 210 or across both ends of the to-be-discharged device 110. The comparison circuit 222 is coupled to the detection circuit 221 and may compare the descent rate in the detected discharge voltage to a predefined threshold, thereby determining whether the descent rate is too low due to an anomaly. The drive circuit 223 may be coupled between the comparison circuit 222 and the controllable switch S1, and the controllable switch S1 may be controlled based on the comparison results of the comparison circuit 222. If the comparison result of the comparison circuit 223 indicates that the descent rate in the discharge voltage is too low and below the threshold, then it means that there is still energy to be continuously input into to-be-discharged device 110 and may cause the primary discharge circuit 210 to be discharged continuously for a long time, causing severe heat and damage. At this point, the drive circuit 223 may turn off the controllable switch S1 to cut off the discharge loop according to the comparison result. If the comparison result of the comparison circuit 222 indicates that the rate of reduction of the discharge voltage is normal, then the discharge process is normal, whereby the drive circuit 223 may not change the on state of the controllable switch S1 such that the primary discharge circuit 210 completes the discharge of to-be-discharged device 110.

In some embodiments of the present disclosure, the protection circuit 220 further includes a power supply circuit 224 coupled to the primary discharge circuit 210 or adapted to couple to the to-be-discharged device 110, and may utilize power from to-be-discharged device 110 to power other circuites in the protection circuit 220. By way of example, the detection circuit 221, the comparison circuit 222, and the drive circuit 223 in the protection circuit 220 may have active devices or need to provide a power voltage. However, during the discharge process, the electrical power supply supporting operation of the electrical device 10 is typically disconnected from the electrical device 10 and therefore it is difficult to utilize the power supply to power the protective circuit 220. By setting up the power supply circuit 224, the energy remaining in the to-be-discharged device 110 may be utilized to power the protection circuit 220, which avoids additional power setup to power the protection circuit 220 and avoids the cost increase. Additionally, it is more advantageous that the use of the residual energy in the to-be-discharged device 110 by the power supply circuit 224 may further accelerate the release of the energy of the to-be-discharged device 110 during the discharge process, thereby reducing the discharge and heat length of the primary discharge circuit 210, which optimizes discharge operations and facilitates protection of the primary discharge circuit 210.

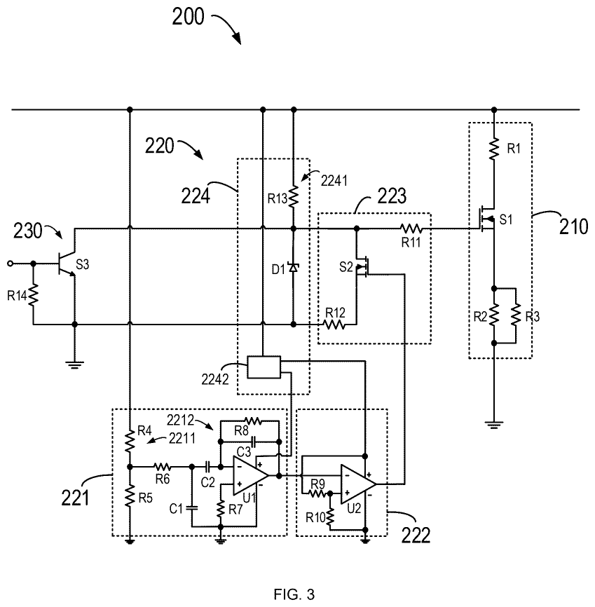

FIG. 3 shows a schematic detailed circuit diagram of a discharge equipment 200, consistent with embodiments of the present disclosure. As shown in FIG. 3, in the primary discharge circuit 210, the discharge resistance RD includes resistance R1, R2, and R3, wherein the resistance R2 and R3 are in parallel with each other, and the resistance R2 and R3 are connected in series with the controllable switch S1 and the resistance R1 to form the primary discharge circuit 210.

In some embodiments, the detection circuit 221 may include a sensing sub-circuit 2211 and a micro-molecule circuit 2212, the sensing sub-circuit 2211 senses the discharge voltage of the to-be-discharged device 110, and the micro-molecule circuit 2212 differentially calculates the sensed discharge voltage. By way of example, the sensing subcircuit 2211 includes a divider voltage circuit consisting of resistance R4 and R5, and the micromolecular circuit 2212 may include resistance R6, R7, and R8, capacitance C1, C2, and C3, and an operational amplifier U1. The divider voltage circuit consisting of resistance R4 and R5 obtains the discharge voltage from the line connected to the to-be-discharged device 110 and outputs the acquired discharge voltage to the micromolecule circuit 2212 after scaling to a partial pressure ratio. The micromolecular circuit 2212 performs a differential operation on the input voltage from the sensing sub-circuit 2211 to determine a descent rate in the discharge voltage.

The comparison circuit 222 includes resistance R9 and R10 and an operational amplifier U2. The output of the micromolecule circuit 2212 represents a descent rate of the discharge voltage and is output to a negative input end of the operational amplifier U2 of the comparison circuit 222. In addition, the resistance R9 and R10 of the group component pressure circuit need to be properly set and selected such that the potential at the dividing node between the resistance R9 and R10 (i.e., the positive input end of the operational amplifier U2) corresponds to a desired threshold of the descent rate, e.g., a minimum descent rate or lower rate in the normal discharge voltage curve. As such, the descent rate of the discharge voltage may be compared with a predefined threshold in the comparison circuit 222 and the comparison result is output.

In some embodiments, the drive circuit 223 may include a first switch device S2, which is coupled to the comparison circuit 222, and may change the level of the control end of the controllable switch S1 if the descent rate is below a threshold to change the controllable switch S1 from an on state to an off state. The first switching device S2 may be an N-type MOSFET or other type of switching device. Further, the drive circuit 223 may also include resistance R11 and R12. For example, when the comparison circuit 222 determines that the descent rate is below a threshold, a high level will be output to the first switching device S2 of the drive circuit 223, whereby the first switching device S2 changes from an off state to an on state. Since the drain of the first switching device S2 is connected to the control end of the controllable switch S1 via resistor R11 and the source of the first switching device S2 is grounded via resistor R12, the first switching device S2 after connecting lowers the control end of the controllable switch S1 to a low level, thereby turning off the controllable switch S1 and cutting off the discharge loop, thereby protecting the discharge equipment 200 and its primary discharge circuit 210 from damage or burnt from prolonged discharge and heat. Further, when the comparison circuit 222 determines that the descent rate is above a threshold, a low level will be output to the first switching device S2 of the drive circuit 223, whereby the first switching device S2 will remain in the off state. At this point, the control end of the controllable switch S1 will be maintained at a high level, and thus the controllable switch S1 remains on to maintain the discharge loop conductance. In other words, the normal discharge of the primary discharge circuit 210 will not be affected if no abnormality is found by the protection circuit 220.

In some embodiments, the power supply circuit 224 may include a series circuit of the divider resistance R13 and the voltage regulator D1, as well as a power transducer 2242. By way of example, the divider resistance R13 and the voltage regulator D1 may receive power from a line connected to the to-be-discharged device 110 and power the drive circuit 223 to provide a power supply voltage. As such, the control end of the controllable switch S1 will be pulled up to a high level to remain in the on state for discharge when the switch device S2 is not on. The power transducer 2242 may be a DC-DC converter, such as a flyback DC-DC converter, and receive power from a line connected to the to-be-discharged device 110 to power an active device (e.g., operational amplifiers U1 and U2) in the detection circuit 221 and the comparison circuit 222 or to provide a power voltage (e.g., for resistance R9 and R10). Alternatively, the power supply circuit 224 may also include only a series circuit consisting of the divider resistance R13 and the voltage regulator D1, or only the power transducer 2242. That is, the protection circuit can also be powered in only one way. Further, it will be understood that the implementation of the power supply circuit 224 is not so limited and that any appropriate means of obtaining power may be used depending on cost or actual demand.

In some embodiments, the primary drive circuit 230 may include a second switch device S3 that may be coupled to a controller (not shown) of the electrical equipment 10 and may change the level of the control end of the controllable switch S1 to change the controllable switch S1 from the off state to the on state if the controller is powered down. The second switch device S3 may be a tri-pole tube or other type of switch device. The primary drive circuit 230 may also include a resistance R14 coupled between the base and the ground of the second switch device S3. As an example, when the electrical device 10 is running normally, the controller of the electrical device 10 may keep the base of the second switch device S3 as high-level, thereby pulling the control end of the controllable switch S1 down to low-level, thereby ensuring that the controllable switch S1 of the primary discharge circuit 210 is in an off state without affecting the operation of the electrical device 10. After the electrical device 10 is stopped and de-energized, the controller or control logic of the electrical device 10 is unable to maintain the base of the second switching device S3 as a high level due to the power being de-energized, so the base of the second switching device S3 is pulled down to the low level. After the second switching device S3 is disconnected, the high-level potential provided by the resistance R13 and the voltage regulator D1 is applied to the control end of the controllable switch S1, triggering the controllable switch S1 to conduct and thereby turn on the discharge. As can be seen, the main drive circuit 230 is used to open the primary discharge circuit 210 for the discharge operation of the discharge equipment 110, while the drive circuit 223 is used to stop the discharge in the event of discharge abnormalities to protect the discharge equipment 200 and the primary discharge circuit 210. However, it will be understood that the functions of the main drive circuit 230 and the drive circuit 223 can also be interchanged, i.e., the discharge is opened by the circuit 223 and a protective power off is achieved by the circuit 230, which can be achieved by modifying the output of the comparison circuit 222 to a switch device connected to the circuit 230. In addition, in some instances, additional drive circuits or circuites may also be provided to receive instructions from personnel or other control units to intervene or interrupt the discharge process, which may increase the flexibility of discharge control and protection.

In embodiments of the present disclosure, the protective mechanism for a discharge equipment is advantageously provided, and it itself may judge whether energy is still continuously input into the to-be-discharged device during the discharge process, and in the event of such an abnormality, may automatically turn off the discharge function, thereby stopping the discharge to protect the discharge equipment and its primary discharge circuit from damage caused by continuous discharge and heat. The discharge equipment of the present disclosure do not require instructions from the controller or control logic of the electrical equipment or other external instructions in the discharge protection process, nor do they require a detection device or sensing device of the electrical equipment to provide voltage and current sensing information, and independent judgment and operation may be performed to protect important discharge equipment from damage. Further, in some embodiments of the present disclosure, where the electrical device itself has been de-energized, the discharge equipment may utilize the residual energy of the device to power the discharge equipment to achieve the desired detection, judgment, and drive functions without the need for an additional power supply, which reduces costs and facilitates advantageously the release of residual energy in the to-be-discharged device.

Many modifications and other embodiments of the present disclosure set forth herein will come to mind to one skilled in the art to which the present disclosure pertains given herein in view of the teachings presented in the foregoing descriptions and the associated drawings. Accordingly, it is to be understood that embodiments of the present disclosure are not limited to the specific embodiments disclosed and that modifications and other embodiments are intended to be included within the scope of the present disclosure. Furthermore, while the above description and the accompanying drawings describe example implementations in the context of certain example combinations of components and/or functions, it should be appreciated that different combinations of components and/or functions may be provided by alternative implementations without departing from the scope of the present disclosure. In this regard, for example, other combinations of components and/or functionality than those explicitly described above are also contemplated to be within the scope of the present disclosure. Although specific terms are used herein, they are used only in a general and descriptive sense and are not intended to be limiting.

1. A discharge equipment (200), comprising:
a primary discharge circuit (210) configured to couple to a to-be-discharged device (110) of an electrical device (10) and comprising a controllable switch (S1) configured to be connectable to form a discharge loop to discharge the to-be-discharged device (110) and configured to be turned off to sever the discharge loop to stop discharge of the to-be-discharged device (110); and
a protection circuit (220) coupled to the primary discharge circuit (210) and configured to turn off the controllable switch (S1) if a rate of descent of a discharge voltage of the to-be-discharged device (110) is below a threshold during discharge of the to-be-discharged device (110).

2. The discharge equipment (200) of claim 1, wherein the protection circuit (220) comprises:
a detection circuit (221) coupled to the primary discharge circuit (210) or configured to couple to the to-be-discharged device (110) and configured to detect a descent rate of the discharge voltage;
a comparison circuit (222), coupled to the detection circuit (221), and configured to compare a detected descent rate to the threshold, wherein the threshold is between 200 volts/second and 500 volts/second; and
a drive circuit (223) coupled to the comparison circuit (222) and the controllable switch (S1) and configured to control the controllable switch (S1) based on a comparison of the comparison circuit (222).

3. The discharge equipment (200) of claim 2, wherein the detection circuit (221) includes a sensing subcircuit (2211) and a micromolecular circuit (2212), the sensing subcircuit (2211) is configured to sense the discharge voltage and the micromolecular circuit (2212) is configured to differentially calculate the sensed discharge voltage.

4. The discharge equipment (200) of claim 2, wherein the drive circuit (223) includes a first switching device (S2) coupled to the comparison circuit (222) and configured to change a level of a control end of the controllable switch (S1) to change the controllable switch (S1) from an on state to an off state if the descent rate is below the threshold.

5. The discharge equipment (200) according to claim 1, further comprising:
a primary drive circuit (230), including a second switch device (S3) configured to couple to a controller of the electrical device (10) and configured to change a level of a control end of the controllable switch (S1) to change the controllable switch (S1) from an off state to an on state if the controller is powered off.

6. The discharge equipment (200) according to claim 1, wherein the protection circuit (220) further comprises:
a power supply circuit (224) coupled to the primary discharge circuit (210) or configured to couple to the to-be-discharged device (110) and configured to power a device in the protection circuit (220) with power from the to-be-discharged device (110).

7. The discharge equipment (200) of claim 6, wherein the power supply circuit (224) comprises at least one of: a series circuit of a divider resistance (R13) and a voltage regulator (D1), and a power transducer (2242).

8. The discharge equipment (200) of claim 1, wherein the primary discharge circuit (210) includes at least one discharge resistance (R1, R2, R3) coupled in series with the controllable switch (S1).

9. An electrical device (10), comprising:
a to-be-discharged device (110); and
the discharge equipment (200) according to claim 1, coupled to the to-be-discharged device (110).

10. The electrical device (10) of claim 9, wherein the electrical device (10) is a power conversion device and the to-be-discharged device (110) is a capacitance.
